(19) United States
(12) Patent Application Publication
(10) Pub. No.: US 2006/0122012 A1
(43) Pub. Date: Jun. 8, 2006

(54) Method for isolating ionomers from a golf ball component

(75) Inventor: Hatsuo Ishida, Shaker Heights, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: The Callaway Golf Company, Carlsbad, CA (US)

(21) Appl. No.: 11/291,567

(22) Filed: Nov. 30, 2005

Related U.S. Application Data
(60) Provisional application No. 60/631,634, filed on Nov. 30, 2004.

(51) Int. Cl. A63B 37/00; A63B 37/14; C08C 1/14

(52) U.S. Cl. 473/378; 473/351; 528/488

(57) ABSTRACT

A method for isolating ionomers of an ionomer blend includes chemically modifying the ionomers of the ionomer blend by esterifying the carboxylic acid groups and then separating the chemically modified ionomers. The ionomers may be separated by taking advantage of the different solubilities of ionomers of different acid compositions and precipitating at least one of the ionomers from the ionomer blend. The method is particularly useful in determining the acid content of the ionomers in a golf ball layer comprising an ionomer blend.

### BACKGROUND

The present disclosure relates, in various exemplary embodiments, to a method of isolating ionomers from a golf ball component. A method in accordance with the present disclosure finds particular application in determining the neutralizing ion and/or acid content of the ionomers present in an ionomer blend used in, for example, a golf ball cover layer and will be described with reference thereto. A method in accordance with the present disclosure, however, is amenable to like applications where it is desirable to isolate and separate the ionomers from an ionomer blend present in a golf ball component.

It is known in the golf ball art to form a golf ball component, such as a golf ball cover layer, from a polymer material comprising an ionomeric resin (ionomer). Ionomeric resins are generally ionic copolymers of an olefin, such as ethylene, and a metal salt of an unsaturated carboxylic acid, such as acrylic acid, methacrylic acid or maleic acid. Metal ions, such as sodium or zinc, are used to neutralize some portion of the acidic group in the copolymer, resulting in a thermoplastic elastomer exhibiting enhanced properties, such as durability, for golf ball cover construction. Ionomeric resins are desirable materials for use in golf ball layers, especially in a cover layer of a golf ball, because they exhibit, in part, enhanced durability as compared to traditional cover materials such as balata, which are easily cut or damaged if mishit.

Some of the advantages gained in increased durability, however, have been offset to some degree by decreases in playability. This is because, although the ionomeric resins are very durable, they also tend to be quite hard when utilized for golf ball cover construction and thus lack the degree of softness required to impart the spin necessary to control the ball in flight. Since most ionomeric resins are harder than balata, the ionomeric resin covers do not compress as much against the face of the club upon impact, thereby producing less spin. In addition, the harder and more durable ionic resins lack the “feel” characteristic associated with the softer balata related covers.

As a result, while there are currently more than fifty (50) commercial grades of ionomers available, both from DuPont and Exxon, with a wide range of properties which vary according to the type and amount of metal ions, molecular weight, composition of the base resin (i.e. relative content of ethylene and methacrylic and/or acrylic acid groups) and additive ingredients, such as reinforcement agents, etc., a great deal of research continues in order to develop golf ball cover compositions exhibiting not only the improved impact resistance and carrying distance properties produced by the “hard” ionomeric resins, but also the playability (i.e. “spin”, “feel”, etc.) characteristics previously associated with the “soft” balata covers, properties which are still desired by the more skilled golfer.

Multilayer covers containing one or more ionomeric resins have also been formulated in an attempt to produce a golf ball having the overall distance, playability and durability characteristics desired. This was addressed in U.S. Pat. No. 4,431,193, where a multilayered golf ball cover is described as having been produced by initially molding a first cover layer on a spherical core and then adding a second cover layer. The first or inner layer is comprised of a hard, high flexural modulus resinous material to provide a gain in coefficient of restitution while the outer layer is a comparatively soft, low flexural modulus resinous material to provide spin and control. The increase in the coefficient of restitution provides a ball which serves to attain or approach the maximum initial velocity limit, as provided by the United States Golf Association (U.S.G.A.) rules. The relatively soft, low flexural modulus outer layer provides for an advantageous “feel” and playing characteristics of a balata covered golf ball.

In various attempts to produce a durable, high spin ionomeric golf ball, the golfing industry has also blended the hard ionomer resins with a number of softer ionomer resins. U.S. Pat. Nos. 4,884,814 and 5,120,791 are directed to cover compositions containing blends of hard and soft ionomeric resins. The hard copolymers typically are made from an olefin and an unsaturated carboxylic acid. The soft copolymers are generally made from an olefin, an unsaturated carboxylic acid and an acrylate ester. It has been found that golf ball covers formed from hard-soft ionomer blends tend to become scuffed more readily than covers made of hard ionomer alone.

Further, ionomer resins may be classified in terms of their acid content. Ionomers containing greater than 16 weight percent acid are generally considered high acid ionomers. Ionomers having an acid content of less than 16 weight percent are considered low acid ionomers. For example, U.S. Pat. No. 6,616,551 discloses that golf ball cover layers may be formed from blends of high acid ionomers, blends of low acid ionomers, or blends of high acid and low acid ionomers.

In some instances, it may be desirable to ascertain the composition of a material comprising an ionomeric resin or blend of ionomeric resins. In particular, it may be desirable or beneficial to be able to determine the acid content of the different ionomeric resins present in an ionomer blend. Compositions comprising a blend of ionomeric resins present difficulties in evaluating the separate ionomeric species in that the carboxylic acid groups of the ionomers tend to cluster or associate with one another. This makes it difficult to dissolve the molecules in ordinary solvents. Further, the clustering effect causes analytical techniques such as, for example, infrared (IR) spectroscopy and nuclear magnetic resonance (NMR) spectroscopy to be overly sensitive to sample condition, which tends to make the results unreliable.

Therefore, it is desirable to provide a method for isolating the ionomers of a golf ball component formed from an ionomer blend and determining certain characteristics of these ionomers.

### BRIEF DESCRIPTION

In accordance with one aspect of the present exemplary embodiment, a method of isolating ionomers from a golf ball component formed from an ionomer blend is provided comprising (i) providing a golf ball component formed from an ionomer blend comprising two or more ionomers; (ii) chemically modifying the ionomers by esterifying at least a portion of the carboxylic acid groups of the ionomers to form a modified ionomer blend; and (iii) separating the ionomers.

In accordance with another aspect of the present exemplary embodiment, a method for isolating ionomers from an ionomer blend comprising two or more ionomers is provided comprising providing an ionomer blend; esterifying at least a portion of the carboxylic acid groups of the two or more ionomers of the ionomer blend by reacting the ionomer blend with a solution comprising an alkyl halide and hexamethylphosphoramide (HMPA), thereby forming a modified ionomer blend; separating at least one ionomer from the modified ionomer by adding the modified ionomer blend to a solvent in which at least one of the ionomers exhibits low solubility, thereby precipitating a first ionomer while leaving one or more remaining ionomers in solution; collecting the first ionomer by filtering off the solution comprising the remaining ionomers; and obtaining the remaining ionomers of the ionomer blend.

In accordance with still another aspect, a method for determining the acid content of the ionomers in a golf ball layer comprising an ionomer blend, the method comprising (i) dissolving a golf ball layer comprising an ionomer blend, thereby forming a polymer solution; (ii) esterifying the ionomers of the polymer solution to form a modified polymer solution; (iii) separating the ionomers from the modified polymer solution by precipitating at least one of the individual ionomers; and (iv) determining the acid content of the separate ionomers by an analytical method. The characteristics of the isolated ionomers can also be further determined.

### BRIEF DESCRIPTION OF THE DRAWINGS

The following is a brief description of the drawings, which are presented for the purposes of illustrating the development disclosed herein and not for the purposes of limiting the same.

FIG. 1 is a representative ¹³C NMR spectra of an ionomer in an ionomer blend that is chemically modified by a process in accordance with the present disclosure.

FIGS. 2 through 9 are ¹³C NMR spectras used to calculate the acid contents of Samples 1-1 through 4-2 of Example 1.

### DETAILED DESCRIPTION

A method for isolating ionomers from an ionomer blend having two or more ionomer species comprises i) modifying the ionomers to an appropriate chemical form, and ii) separating the ionomers via an appropriate separation technique. After separation, the ionomers may be analyzed via an appropriate analytical tool such as, for example, NMR.

To isolate the ionomers of an ionomer blend, the ionomers are modified to an appropriate chemical form to yield a modified ionomer blend. Modifying the chemical form of the ionomers in an ionomeric blend is necessary to prevent the acid moieties of the ionomers from associating with one another. The ionomeric resins may be chemically modified to any desired chemical form that will prevent the acid moieties of the ionomers from associating with one another.

In one embodiment, the ionomeric resins are modified by esterification of the carboxylic acid groups of the ionomer resins. The carboxylic acid groups of the ionomeric resins may be esterified by any suitable method. A suitable method for esterifying carboxylic acids is disclosed in an article titled “A Simple Quantitative Method for the Esterification of Carboxylic Acids” (James E. Shaw, et al., Tetrahedron Letters, No. 9, 689-92 (1973)), the entire disclosure of which is incorporated herein by reference. The method disclosed in the Shaw et al. article includes reacting the salt of a carboxylic acid with an alkyl bromide or iodide in hexamethylphosphoramide (HMPA) at room temperature. In one embodiment, the carboxylic acid groups of an ionomer blend may be esterified by reacting the ionomer blend with a solution comprising HMPA and an alkyl halide. An example of a suitable alkyl halide includes, but is not limited to, methyl iodide. The mixture of HMPA and the alkyl halide may be added to the ionomer blend over a period of from about 1 to about 48 hours. The esterification procedure may be modified as necessary to sufficiently esterify the ionomeric resins. For example, ionomers blends comprising blends of ethylene-methacrylic acid ionomers may require refluxing the reaction mixture. Additionally, the esterification reaction may be carried out over a period of from about 15 minutes to about 216 hours (about 9 days). In one embodiment, the esterification reaction is allowed to proceed for about 72 hours (about 3 days).

It is desirable that the chemical modification, such as by esterification, be as close to 100% complete as possible. That is, it is desirable that 100% of the carboxylic acid groups on each ionomer species be chemically modified, such as by esterification of the carboxylic acid groups. The degree of modification, such as by esterification, may have an effect on the solubility of the modified ionomers in various solvents and may limit or affect the analysis of the ionomers by certain analytical techniques.

Following chemical modification of the ionomers, the ionomeric species are separated. Separating the ionomers is necessary for further analysis of an ionomer blend because the ionomer blend, such as used in golf ball covers, are not a single component, but a mixture of different ionomers. The modified ionomer blend comprising the chemically modified ionomers may be separated by any suitable technique.

In one embodiment, the (modified) ionomeric resins may be separated by chromatographic techniques. While, chromatographic techniques are suitable for separating the modified ionomeric resins, such methods tend to be limiting in terms of the amount of (modified) ionomeric resin species that may be obtainable. Namely, chromatographic methods tend to limit the quantity of (modified) ionomeric resin species to microgram quantities, which may not be sufficient to obtain a high signal-to-noise ratio for further analysis of the ionomers such as by, for example, NMR. NMR generally requires at least milligram quantity samples for suitable analysis.

In another embodiment, the (modified) ionomeric resin species are separated by precipitation techniques. In particular, different ionomeric resin components (which differ in terms of composition and/or acid content) exhibit different solubilities. Thus, an ionomeric species may be precipitated by adding a solution comprising the chemically modified ionomeric resins to an appropriate solvent in which one of the ionomeric species exhibits low or no solubility. An ionomeric species precipitates out while other ionomeric species remain in the supernatant. The solid ionomeric species may be obtained by filtration. The subsequent supernatant/filtrate contains the other ionomeric species. The process may be repeated as necessary to separate out each ionomeric species of the blend. For example, the supernatant/filtrate may be added to an appropriate solvent to precipitate out another (second) ionomeric species, and the precipitation procedure repeated to precipitate a third, fourth, etc. ionomeric species. In another embodiment, the final ionomeric species may be obtained by evaporating off the solvent(s).

In one embodiment wherein an ionomer blend contains a first ionomer and a second ionomer, the ionomeric species may be obtained. Following chemical modification, such as by esterification of the carboxylic acid groups of the ionomers, a first ionomer may be obtained by adding the chemically modified ionomer blend to a solvent, such as, for example, tetrahydrofuran (THF), in which one of the solvents exhibits low or no solubility. A first ionomer precipitates from the solution of the chemically modified ionomer blend due to poor solubility in the selected solvent, e.g., THF. The solution is filtered to obtain the first ionomer and a filtrate containing the second ionomer. The second ionomer may then be obtained by evaporating the solvent, e.g., THF to yield a solid second ionomer species. The samples may be washed and dried as desired.

Any suitable solvent may be used to precipitate an ionomer species from the chemically modified ionomer blend solution. The solvent used may be selected as desired based on the solubility of a given ionomer (for modified ionomer) in a given solvent. An example of a suitable solvent is THF.

Following separation of the ionomer species, the ionomer species may be analyzed, if desired, by any suitable analytical method or technique. For example, the ionomeric species may be analyzed by, for example, NMR, to determine the acid content of the different ionomer species.

The present method is suitable for use in studying the layers of a golf ball. In particular, the present method is useful for determining the composition of a golf ball layer, such as, for example, a cover layer, comprising an ionomer blend. The method is suitable for use in studying ionomer blends comprising ionomers having various acid contents and/or polymer structures (i.e., components such as methacrylic acid, ethacrylic acid, maleic acid, and the like).

A method for isolating ionomers is further described with reference to the following examples. The examples are merely for purposes of illustrating a method in accordance with the present disclosure and are not intended to be limiting in any manner.

### EXAMPLES

### Example I

The inner cover materials of four different golf balls were analyzed to determine the acid content of the ionomers in the cover material. The inner cover layers were obtained by cutting a golf ball in half and then cutting away a portion of the outer cover layer to expose the inner cover layer. A portion of the inner cover layer was then removed for analysis.

The cover layer material was chemically modified by esterifying the carboxylic acid groups of the ionomers as follows. One gram of the inner cover layer polymer material was dissolved in 25 ml of tetrahydrofuran (THF) at 80° C. for 30 minutes to obtain a polymer solution. A solution of 0.5 grams of NaOH in 5 ml of water was added to the polymer solution. The polymer solution was stirred at the reflux temperature for 1 hour, after which 50 ml of hexamethylphosphoramide (HMPA) was added to the polymer solution. A solution of 5 grams of methyl iodide (CH₃l) in 10 ml of HMPA was added dropwise to the polymer solution over a period of two days. The solution was kept stirring at the reflux temperature. The reaction was allowed to proceed for 3 days. The solution was then purged in cool water and filtered. The solution was washed with water and dried overnight.

The ionomers of the cover material were separated by adding 0.5 grams of the chemically modified polymer to a stirring solution of 20-25 ml of THF at room temperature. One of the ionomer components precipitated. The solution was filtered under reduced pressure to obtain a solid ionomer component (which will be designated as ionomer number 2 for each of the golf ball samples). A clear solution remained after filtration. THF was evaporated from the clear solution and a solid was collected (the solid collected after evaporation is designated as ionomer number 1 for each of the golf ball samples). Both solids were dried under vacuum at 50° C. overnight.

The purified ionomer samples were analyzed via NMR spectroscopy. The purified ionomer samples were sufficiently soluble in NMR solvents to obtain spectra with a signal-to-noise ratio for a preliminary investigation after six hours of scans per spectrum for ¹³C NMR analysis. Complete separation ¹³C NMR resonances was suitable for the intended analysis of the acid content of the ionomers.

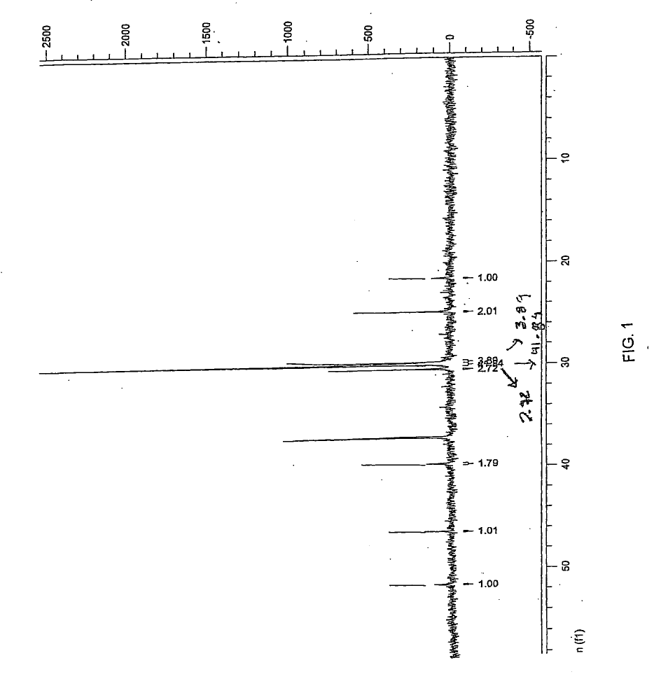

FIG. 1 depicts a representative ¹³C NMR spectra of a chemically modified ionomer prepared in accordance with the present process. The assignment of each resonance is shown in Table 1. Formula I shows the carbon atom designation for the chemical group assigned to each resonance.

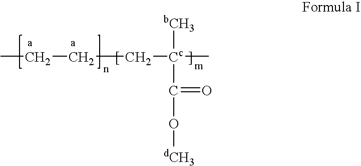

TABLE 1

| Carbon Designation | Chemical Group | Frequency Observed (rpm) |
|---|---|---|
| a | CH₂ (ethylene) | 30.0 |
| b | CH₃ (methyl) | 21.5 |
| c | Quaternary carbon | 46.3 |
| d | CH₃ (methoxy) | 51.5 |

The intensities of the b, c, and d carbon resonances are identified within experimental error. This supports the quantitative nature of the analysis since one carbon atom of each group exists in the chemical repeat unit of the acid moiety. Further, even though there is a high noise level which makes it difficult to ascertain whether 100% of the carboxylic acid has been modified, the d carbon shows nearly the same intensity as the other non-chemically modified carbons, indicating that the chemical modification, i.e., the esterification, is nearly complete. There may in fact be some minute amount of carboxylic acid that remains unmodified, which may have a slight adverse affect on the solubility of the modified ionomers in the NMR solvent.

The ionomers of each golf ball sample was analyzed by NMR spectroscopy using a Varian Model 958220-06 with a proton frequency of 300 MHz and carbon frequency of 51 Mz. The data acquisition condition was:

| | |
|---|---|
| Solvent | CDCl₃ |
| Temperature | 60° C. |
| Number of transient: | 2,000 |
| Contact time: | 15 seconds |

Table 2 lists the acid content in weight percent of each ionomer of the golf ball inner cover layers.

TABLE 2

| Golf Ball | Ionomer Number | Acid Content (wt. %) |
|---|---|---|
| 1 | 1 | 12.9 |
| 1 | 2 | 21.4 |
| 2 | 1 | 13.2 |
| 2 | 2 | 19.7 |
| 3 | 1 | 13.1 |
| 3 | 2 | 17.4 |
| 4 | 1 | 15.1 |
| 4 | 2 | 20.8 |

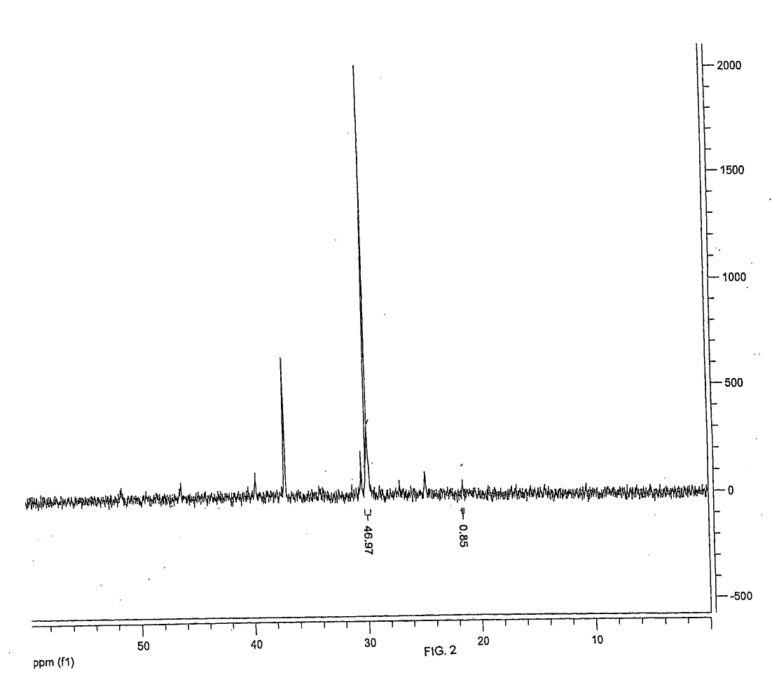

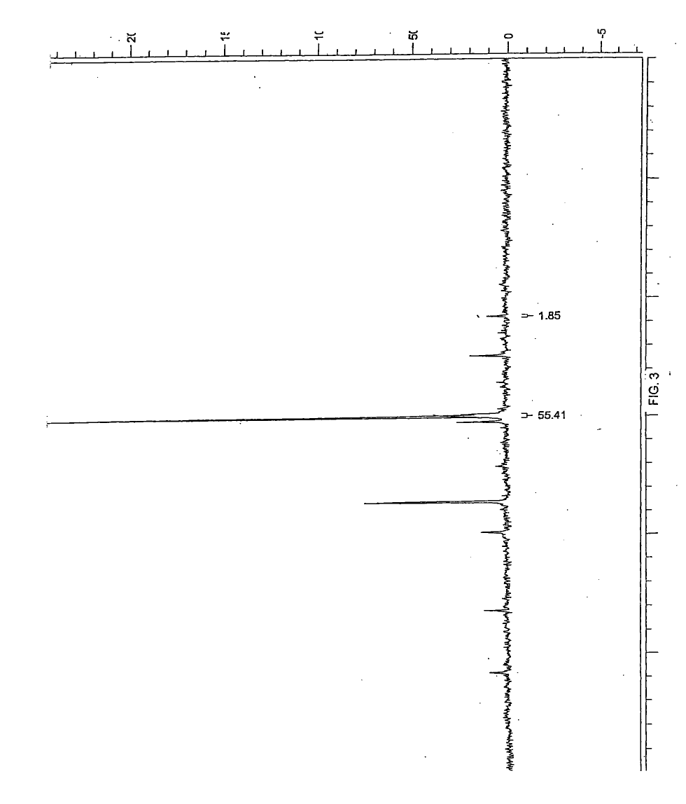

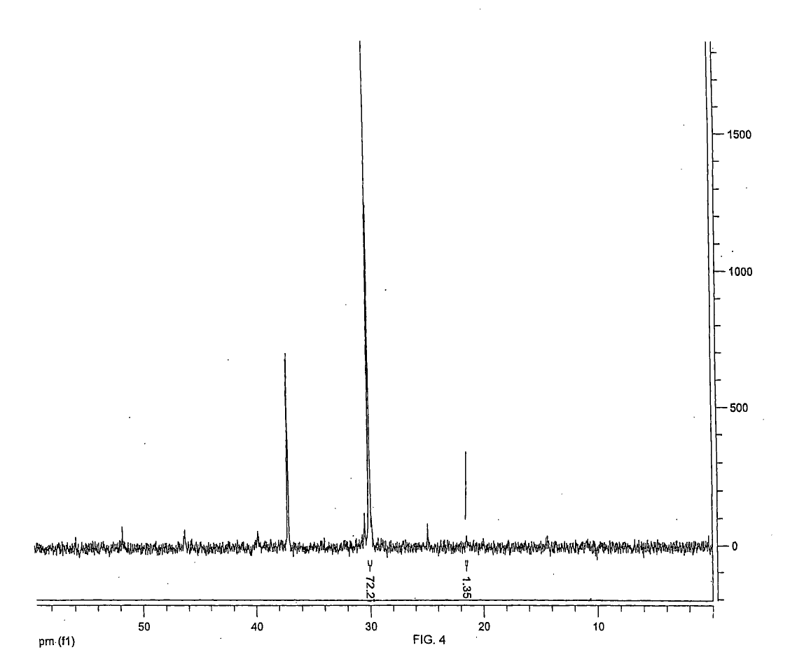

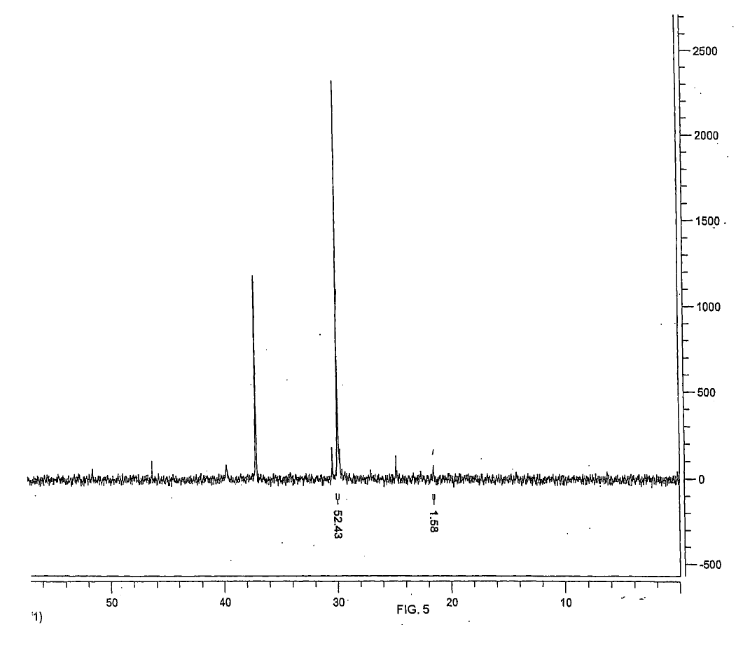

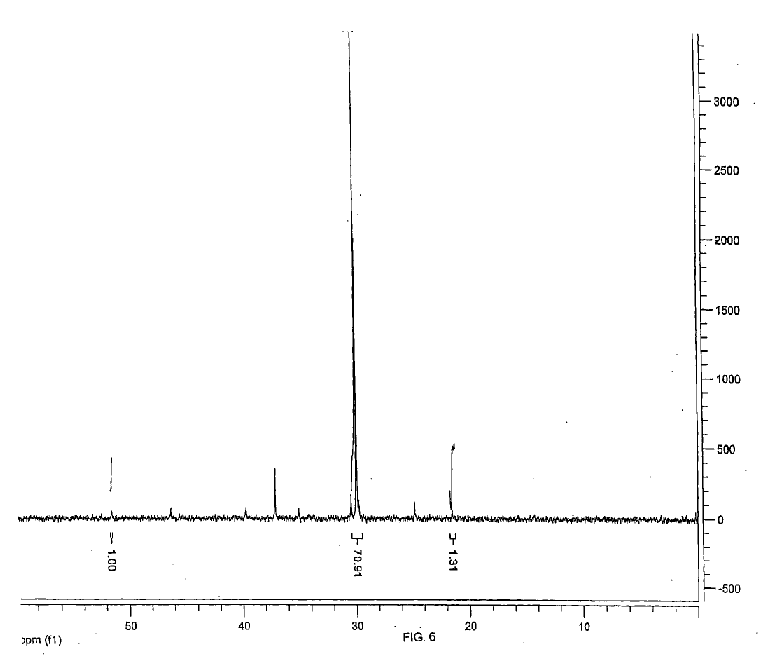

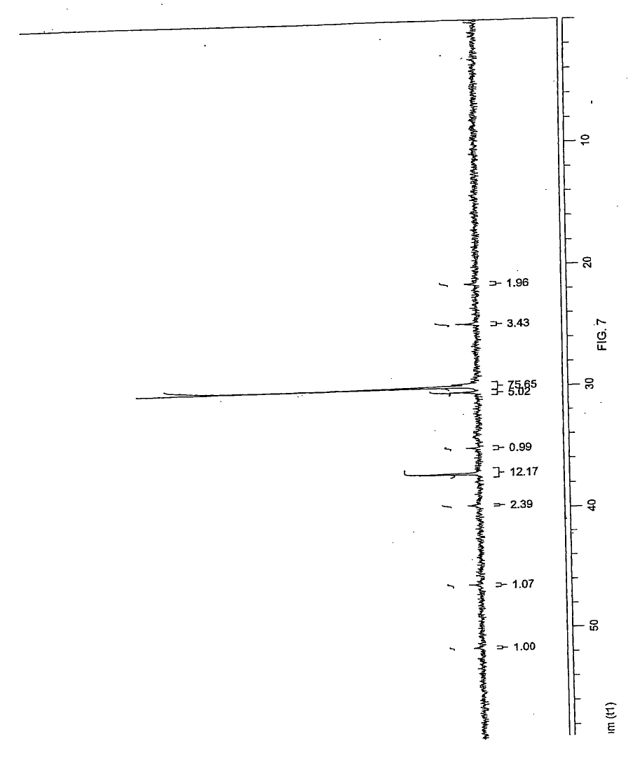

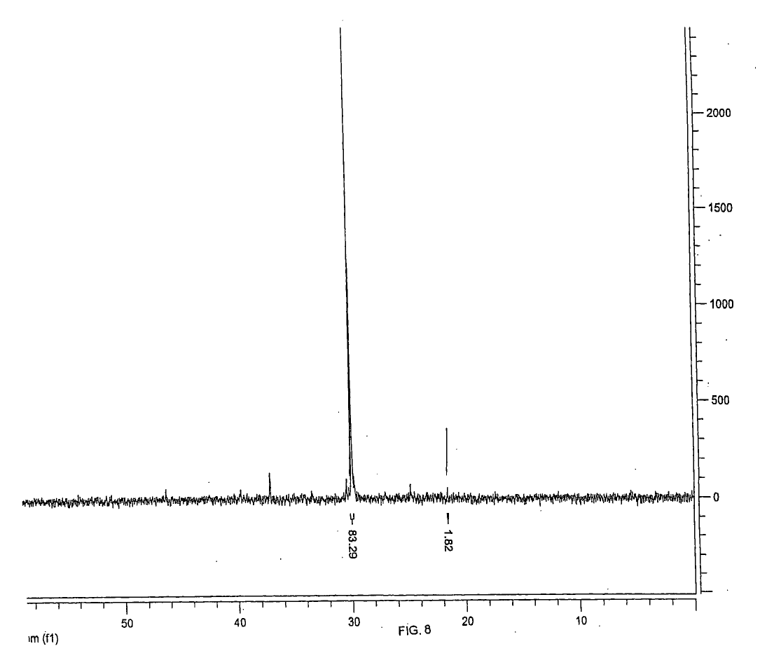

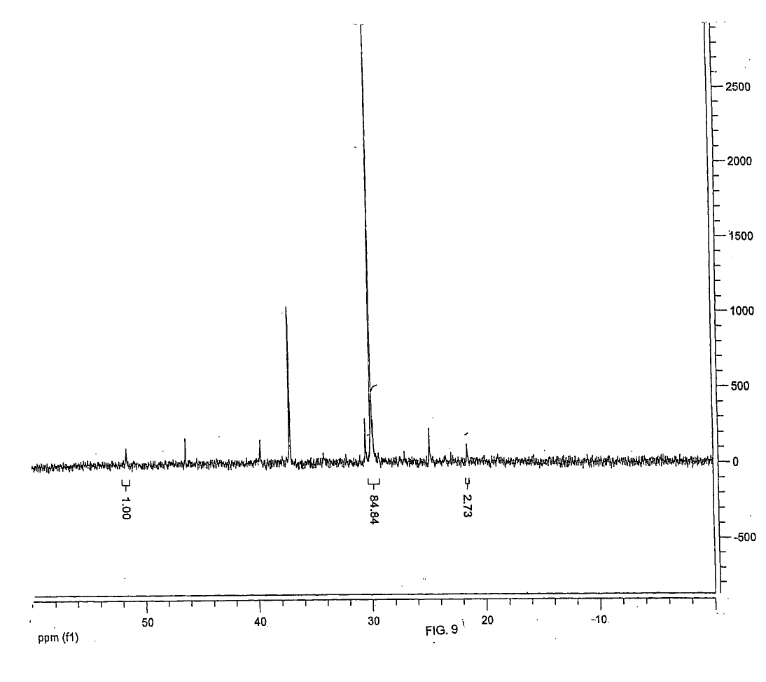

The ¹³C NMR spectra used to calculate the acid contents are shown in FIGS. 2 through 9 for Samples 1-1 through 4-2, respectively. The signal-to-noise ratio of the NMC peak used in the analysis of the acid content was about 4:1, but due to the mathematical data analysis procedure used, the accuracy of the analysis is not as poor as the S/N ratio might indicate. And in fact, as observed above, the signal-to-noise ratio was sufficient to analyze the ionomers.

Furthermore, to improve the signal-to-noise ratio, a 600 MHz NMR may be used in place of the 300 MHz machine. In modifying the carboxylic acid groups of the ionomers, the reaction time may be increased from 3 to 9 days. Dimethyl sulfoxide (DMSO) may be used as the NMR solvent and the test temperature may be increased from 60° C. to 110° C., thereby increasing the solubility of the chemically modified ionomers.

The exemplary embodiment has been described with reference to the various embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of isolating ionomers from an ionomer blend, the method comprising:
(i) providing an ionomer blend comprising two or more ionomers;
(ii) chemically modifying the ionomers by esterifying at least a portion of the carboxylic acid groups of the ionomers to form a modified ionomer blend; and
(iii) separating the ionomers.

2. The method according to claim 1, wherein at least a portion of the carboxylic acid groups are esterified by reacting the ionomer blend with a solution comprising an alkyl halide and hexamethylphosphoramide (HMPA).

3. The method according to claim 1, wherein at least a portion of the carboxylic acid groups are esterified by reacting the ionomer blend with a solution comprising a methyl halide and hexamethylphosphoramide.

4. The method according to claim 3, wherein the methyl halide is methyl iodide.

5. The method according to claim 1, wherein the chemically modified ionomers are separated by column chromatography.

6. The method according to claim 1, wherein the chemically modified ionomers are separated by separately precipitating at least one of the chemically modified ionomers.

7. The method according to claim 6, wherein at least one of the two or more ionomers is precipitated by adding the modified ionomer blend to THF.

8. The method according to claim 6, wherein one or more ionomers remain in solution after precipitating one of the ionomers from the blend, and at least one of the one or more ionomers remaining in solution is separated out by precipitating the at least one of the one or more remaining ionomers from the solution.

9. The method according to claim 1, wherein the ionomer blend comprises a first ionomer and second ionomer, and the ionomers are separated by a) precipitating a first ionomer by adding the modified ionomer blend to a solvent in which the first ionomer exhibits low solubility, while the second ionomer remains in solution, b) collecting the first ionomer by filtering off the solution and c) obtaining the second ionomer by evaporating the solution remaining after filtration in step (b).

10. A method for isolating ionomers from an ionomer blend comprising two or more ionomers, the method comprising:
providing an ionomer blend;
esterifying at least a portion of the carboxylic acid groups of the two or more ionomers of the ionomer blend by reacting the ionomer blend with a solution comprising an alkyl halide and hexamethylphosphoramide (HMPA), thereby forming a modified ionomer blend;
separating at least one ionomer from the modified ionomer by adding the modified ionomer blend to a solvent in which at least one of the ionomers exhibits low solubility, thereby precipitating a first ionomer while leaving one or more remaining ionomers in solution;
collecting the first ionomer by filtering off the solution comprising the remaining ionomers; and
obtaining the remaining ionomers of the ionomer blend.

11. The method according to claim 10, wherein the ionomers remaining in solution are further separated by precipitating out one ionomer from the solution and repeating as necessary until all the ionomers have been separated.

12. The method according to claim 10, wherein the ionomer blend comprises a first ionomer and a second ionomer, and the second ionomer is obtained by evaporating the solvent from the solution remaining after precipitation of the first ionomer and filtration.

13. The method according to claim 10, wherein the alkyl halide is methyl iodide.

14. The method according to claim 10, wherein the solution comprising HMPA and the alkyl halide is added to the ionomer blend over a period of about 1 to about 48 hours.

15. The method according to claim 10, wherein the solvent is tetrahydrofuran.

16. A method for determining the acid content of the ionomers in a golf ball layer comprising an ionomer blend, the method comprising:
(i) dissolving a golf ball layer comprising an ionomer blend, thereby forming a polymer solution;
(ii) esterifying the ionomers of the polymer solution to form a modified polymer solution;
(iii) separating the ionomers from the modified polymer solution by precipitating at least one of the individual ionomers; and
(iv) determining the acid content of the separate ionomers by an analytical method.

17. The method according to claim 16, wherein the ionomers are esterified by reacting the polymer solution with a solution comprising an alkyl halide and hexamethylphosphoramide.

18. The method according to claim 17, wherein the alkyl halide is methyl iodide.

19. The method according to claim 16, wherein a first ionomer is precipitated by adding the modified polymer solution to tetrahydrofuran.

20. The method according to claim 16, wherein the golf ball layer comprises an ionomer blend of a first ionomer and a second ionomer, and the ionomers are separated and obtained by a) adding said modified polymer solution to a solvent, thereby precipitating a first ionomer and a supernatant comprising said second polymer, b) collecting said first ionomer by filtration, and c) obtaining a solid second ionomer by evaporating said supernatant.

21. The method according to claim 16, wherein the acid content of the ionomers is determined by NMR spectroscopy.
